(19) United States
(12) Patent Application Publication
(10) Pub. No.: US 2005/0101806 A1
(43) Pub. Date: May 12, 2005

(54) Process for the catalytic preparation of alkali metal alkoxides

(76) Inventors: Kerstin Schierle-Arndt, Zwingenberg (DE); Andreas Ansmann, Wiesloch (DE); Hans-Josef Sterzel, Dannstadt-Schauernheim (DE); Dieter Schlafer, Ludwigshafen (DE); Josef Guth, Freinsheim (DE); Holger Friedrich, Bobenheim-Roxheim (DE)

Correspondence Address: Herbert B. Keil;KEIL & WEINKAUF, 1350 Connecticut Ave., N.W., Washington, DC, 20036, US

(21) Appl. No.: 10/982,850

(22) Filed: Nov. 8, 2004

(30) Foreign Application Priority Data
Nov. 10, 2003 (DE) 10352877.6

(51) Int. Cl. C07F 1/04; C07F 1/06

(52) U.S. Cl. 568/840

(57) ABSTRACT

Alkali metal alkoxides are prepared by reacting alkali metal amalgam with alcohol in the presence of a catalyst comprising porous iron.

The present invention relates to a process for the catalytic preparation of alkali metal alkoxides by reacting alkali metal amalgam with an alcohol in the presence of a catalyst.

Alkali metal alkoxides (systematic name: “alkali metal alkanolates”) are well-known reagents in organic chemistry. They are used where strong bases are required as reactants and are employed as catalysts for particular reactions. Virtually only the aliphatic alkali metal alkoxides of lithium, sodium and potassium having from 1 to 4 carbon atoms in the alkyl radical of the alcohol, in particular lithium, sodium and potassium methoxide, ethoxide, n-propoxide, isopropoxide, n-butoxide and tert-butoxide, are produced and used in relatively large quantities. A number of methods for preparing alkali metal alkoxides are known. The most widespread are reaction of the alkali metal with the alcohol with evolution of hydrogen and reaction of the alkali metal hydroxide with the alcohol with removal of the water formed as by-product. A method specifically for the preparation of higher alkali metal alkoxides is reaction of an alkali metal methoxide or ethoxide with a higher alcohol with removal of methanol or ethanol. This latter process and the reaction of alkali metal hydroxide with alcohol with removal of the by-product water are frequently inferior from an economic point of view to the direct reaction of alkali metal with alcohol, since they are comparatively energy intensive.

The direct reaction of an alkali metal with an alcohol is the simplest way of preparing alkali metal alkoxides. The reactivity of the alkali metals increases in the order lithium, sodium, potassium, rubidium and cesium, and the reactivity of the alcohols decreases with the molecular weight of the alcohol and the degree of branching of the alkyl radical. The reaction is advantageously carried out using a dispersion of the alkali metal in an inert solvent or using alkali metal amalgam. A general overview of aliphatic alkali metal alkoxides, their preparation and use is given, for example, in Ullmann's Encyclopedia of Industrial Chemistry, Sixth Edition, volume 2, WILEY-VCH Verlag GmbH & Co. KgaA, Weinheim 2003 (ISBN 3-527-30385-5), as point 4 under the keyword “Alcohols, Aliphatic”. An overview of the industrial preparation of alkali metal alkoxides from alkali metal amalgam and reaction apparatuses used for this purpose is given by, for example, R. B. MacMullin in: “By-Products of Amalgam—type Chlorine Cell”, Chemical Engineering Progress September 1950, pp. 440-455, 448.

In the case of the preparation of higher alkali metal alkoxides, which for the purposes of the present invention are alkoxides having at least 3 carbon atoms in the organic radical, the procedure described by MacMullin, I.c., can be employed but is frequently economically unsatisfactory because of low reaction rates. Processes which make it possible to achieve a higher space-time yield by use of a catalyst have therefore been developed.

Such catalytic processes have been known for a long time. Thus, U.S. Pat. No. 2,069,403 teaches a process for preparing alkali metal alkoxides by reacting alkali metal amalgam with alcohols having up to 4 carbon atoms, in which the reaction is carried out in the presence of a catalyst comprising graphite or iron-chromium alloys which may, if desired, further comprise additional alloying constituents such as nickel, molybdenum, tungsten, manganese. A specific embodiment of this process and a typical decomposer (reactors for reacting amalgam with alcohol or water are usually referred to as “decomposers”) are disclosed in U.S. Pat. No. 2,336,045. Here, the amalgam and the alcohol are passed in countercurrent through the decomposer in which the catalyst is present in the form of packing. In these documents, the catalyst is referred to as “electrode”.

In the process of U.S. Pat. No. 2,761,880 (or the equivalent DE 928 467), the alkali metal amalgam is used in the form of a dispersion and is conveyed in countercurrent to the alcohol, with electrode graphite, activated carbon and/or iron turnings being additionally used as catalyst. A preferred catalyst is a mixture of activated carbon with 10-20% of iron turnings. DE 973 323 discloses a catalyst containing 0.1-10% by weight of a metal of the iron group, in particular iron or nickel, on a graphite support. EP 177 768 A1 teaches a catalyst for alkali metal alkoxide production which comprises heavy metal oxide or oxides, in particular a mixture of nickel oxide and molybdenum oxide, applied to the surface of a particulate anthracite support. U.S. Pat. No. 5,262,133 teaches the use of tungsten carbide, iron on carbon supports, iridium, ruthenium or mixtures thereof as catalyst. EP 810 193 A2 discloses catalysts comprising carbides and nitrides of chromium, molybdenum or tungsten, and also catalysts comprising titanium carbide. In the process of DE 198 02 013 A1, catalysts comprising transition metal carbides, nitrides or carbonitrides, in particular molybdenum carbide or tungsten carbide, are used in powder form, while in the process of EP 1 018 499 A2, this powder catalyst is suspended by action of ultrasound. EP 1 195 369 A1 teaches the use of a catalyst comprising iron having a carbon content of at least 0.3% by weight for alkali metal amalgam decomposition.

There continues to be a need for improved processes, in particular processes having an improved space-time yield, in which the catalysts used should be as inexpensive as possible. It was therefore an object of the invention to find a simple, economically satisfactory process which makes it possible to achieve a very high space-time yield and makes do with an inexpensive catalyst.

Accordingly, we have found a process for preparing alkali metal alkoxides by reacting alkali metal amalgam with alcohol in the presence of a catalyst comprising porous iron.

The catalyst used in the process of the invention is inexpensive, displays a long operating life and makes it possible to achieve high space-time yields. A particular advantage of the process of the invention is that it can be carried out without problems in existing decomposers, so that no modification of existing plants is necessary.

As alkali metal, lithium, sodium, potassium, rubidium or cesium is used in the process of the invention. Preference is given to using sodium or potassium. The alkali metal amalgam containing the alkali metal used can be produced by any known method of preparing alkali metal amalgam, for example by mixing alkali metal and mercury, but is usually produced in a known manner by electrolysis of a solution of an appropriate salt, for example a halide, in general the alkali metal chloride, in an electrolysis cell. A particularly suitable type of electrolysis cells for this purpose is that in which the known amalgam process for preparing chlorine and sodium hydroxide is usually carried out. The amalgam generally contains at least 0.05% by weight of alkali metal, preferably at least 0.1% by weight and particularly preferably at least 0.2% by weight. It generally contains not more than 1% by weight of alkali metal, preferably not more than 0.7% by weight and particularly preferably not more than 0.5% by weight.

As alcohol, it is in principle possible to use any compound having a hydroxy group on a carbon-containing radical. In general, use is made of aliphatic alcohols, in particular those having a straight-chain or branched carbon radical containing from one to 8 carbon atoms. Preference is given to using primary, secondary or tertiary alcohols having from one to 5 carbon atoms, particularly preferably those having from one to four carbon atoms. Examples of alcohols used in the process of the invention are methanol, ethanol, n-propanol, isopropanol, n-butanol, 2-butanol (sec-butanol) 2-methyl-1-propanol (isobutanol), 2-methyl-2-propanol (tert-butanol), 1-, 2- or 3-pentanol, neopentanol, tert-pentanol, hexanol, heptanol and octanol.

The economically most important and therefore preferred products of the process of the invention are sodium and potassium methoxide, ethoxide and tert-butoxide. The use of methanol, ethanol or tert-butanol is therefore preferred.

It is likewise possible to use alcohols having more than one hydroxy group, for example glycol.

After the alkali metal alkoxides have been formed by replacement of the hydrogen atom of the hydroxy group of the alcohol by the alkali metal, the alkyl radical of the alcohol used is retained directly in the alkali metal alkoxide.

The process of the invention is particularly useful for preparing sodium methoxide, potassium methoxide, sodium ethoxide, potassium methoxide, sodium tert-butoxide and potassium tert-butoxide.

The catalyst is porous. Porosity is the presence of pores in a material and can therefore naturally only occur in solids. A measure of the porosity is the degree of porosity, viz. the ratio of the volume of the pores in a shaped body to the volume of the shaped body. However, the volume of the pores is usually reported as volume of the pores per gram of the material, for instance in the unit milliliters per gram. It can be measured in a simple fashion by absorption of a fluid into the porous material until the latter is saturated and determination of the amount taken up. These methods are routine (for instance mercury porosimetry or measurement of adsorption isotherms, usually by the BET method (automated analytical instruments are commercially available for both methods) or in the simplest form the “water uptake”, viz. the difference in weight between the dry material and the material impregnated to saturation with water). Another possible way of expressing the porosity is via the surface area of the material. The total surface area of a porous material is formed substantially by the surface area of its pores (the “internal surface area”) and is therefore always greater than the geometric surface area of the shaped body concerned. A high total surface area is therefore always associated with a high porosity, as long as the material in question is not made up of a quantity of extraordinarily fine particles having a correspondingly high geometric surface area. The total surface area of a porous material is usually determined by measurement of adsorption isotherms, mostly by the BET method. It is therefore often also referred to as “BET surface area”, which always means, in the absence of any other indication, the specific surface area in square meters of surface area per gram of material. The geometric surface area of an iron sphere having a radius of, for example, 2 mm and weighing 2.6 gram (density of iron=7.873 g/cm³) is, for example, 0.5 cm², corresponding to a specific surface area of 19×10⁻⁶ m²/g. In the case of irregularly shaped bodies or those having a rough surface, this geometric surface area can be higher and can reach a few tenths of m²/g, e.g. 0.3 m²/g. Extraordinarily fine powders can also have a significantly higher BET surface area which is formed substantially by the external surfaces of the individual particles.

In the process of the invention, porous iron having a BET surface area of generally at least 1 m²/g, preferably at least 2 m²/g and particularly preferably at least 3 m²/g, and generally not more than 100 m²/g, preferably not more than 50 m²/g and particularly preferably not more than 20 m²/g, is used. A well-suited catalyst has, for example, a BET surface area of at least 4 or at least 6 m²/g, and also, for example, not more than 10 m²/g or not more than 8 m²/g.

In a preferred embodiment, the catalyst comprises porous alpha-iron (α-iron), and the iron in the catalyst is, in this preferred embodiment, thus at least partly present in the form of alpha-iron. Alpha-iron is one of the enantiotropic modifications of the element iron, namely that having a body-centered cubic crystal structure and, below its Curie temperature of 768° C., ferromagnetic properties. Alpha-iron is thus not permanently magnetic like iron having a significant carbon content (>0.1% by weight of C).

Apart from iron, the catalyst can further comprise additional elements. These can, firstly, be unavoidable impurities which originate from the raw material and any materials used in processing and cannot be removed or be removed only at disproportionate cost during the process of manufacture but have not been added deliberately. Secondly, additives can also be added deliberately to the catalyst (known as “promoters”) so as to exert an influence on its catalytic properties.

The catalyst used in the process of the invention preferably contains one or more promoters from the following two groups of promoters:
a) at least one promoter selected from the group consisting of aluminum, silicon, zirconium, titanium and manganese and the compounds of these elements,

and/or
b) at least one promoter selected from among the alkali metals (Li, Na, K, Rb, Cs) and the alkaline earth metals (Mg, Ca, Sr, Ba).

These promoters are usually present in the catalyst as oxides or hydroxides.

The promoters of group a) are, if they are used, in each case used in an amount which generally corresponds to a content of at least 0.001% by weight of the respective element (i.e. Al, Si, Zr, Ti or Mn), based on the total mass of the catalyst, preferably at least 0.005% by weight and particularly preferably at least 0.01% by weight, and generally not more than 3% by weight, preferably not more than 1% by weight and particularly preferably not more than 0.3% by weight.

The promoters of group b) are, if they are used, in each case used in an amount which generally corresponds to a content of at least 0.0001% by weight of the respective element (i.e. alkali meal or alkaline earth metal), based on the total mass of the catalyst, preferably at least 0.0005% by weight and particularly preferably at least 0.001% by weight, and generally not more than 3% by weight, preferably not more than 0.5% by weight and particularly preferably not more than 0.25% by weight.

The alpha-iron should have a very low content of carbon incorporated as a homogeneous dispersion in the metallic phase (also referred to as “dissolved” carbon). Its content of such carbon is preferably not more than 0.1% by weight, based on the amount of alpha-iron, and is particularly preferably not more than 0.05% by weight. However, it is possible for carbon precipitated from the metallic phase to be present in the catalyst, typically in the form of relatively large, loose or inhomogeneously distributed graphite particles. These have no significant influence on the process.

In principle, any iron-based catalyst for the synthesis of ammonia from nitrogen and hydrogen can be used in the process of the invention. Ammonia catalysts based on iron, their preparation and use are well known. An overview of ammonia catalysts, their preparation and use is given in, for example, Ullmann's Encyclopedia of Industrial Chemistry, Sixth Edition, volume 2, WILEY-VCH Verlag GmbH & Co. KgaA, Weinheim 2003 (ISBN 3-527-30385-5), as point 4 under the keyword “Ammonia”. Suitable catalysts for the process of the invention are also commercially available as ammonia catalysts, either as catalyst precursors containing iron oxide or as prereduced and passivated catalysts, for instance from Haldor Topsøe A/S, Lyngby, Denmark, under the product numbers KM1 or, in reduced and passivated form, KM1R, from Synetix, Billingham, UK (a subsidiary of Johnson Matthey plc), under the product numbers S6-10, 35-4 or 74-1 or, in each case in prereduced and passivated form, S6-10R, 35-8 or 74-1R, or from Süd-Chemie AG, Munich, Germany, under the product numbers AS-4 or, prereduced and passivated, AS-4F. The S6-10 and S6-10R from Synetix were marketed until 1996 by BASF Aktiengesellschaft, so that they are still referred to as BASF catalysts in some references.

The catalyst is prepared by the methods known for preparing ammonia catalysts, like these from iron-containing raw materials. Suitable raw materials are iron oxides or iron ores, in particular those in which the iron is present to an extent of from 90 to 100% by weight in the form of iron oxide, iron hydroxide, iron oxide hydroxide or mixtures thereof. Preference is given to using synthetically produced or naturally occurring limonite, hematite, wuestite or magnetite or mixtures thereof. Some of the naturally occurring raw materials have the promoters suitable for the catalyst present in the correct amounts, otherwise suitable precursor compounds of the promoters, for instance their oxides or hydroxides, are added to them.

If the iron oxide raw materials are prepared synthetically, they can be produced from very pure metallic iron or very pure iron(II) and/or iron(III) compounds to which the promoters selected are added in the appropriate amount. These processes are known. Typically, at least one soluble iron salt and soluble salts of the desired promoters are dissolved in a solvent, conveniently water, and an iron-containing raw material for preparing the catalyst is precipitated (for instance by increasing the temperature or the pH of the solution or by adding reducing agents). Suitable soluble salts of iron and promoters are, for example, their nitrates, chlorides, acetates, formates and sulfates, preferably the nitrates.

The catalyst precursors obtained in this way are usually dried at temperatures in the range from 80 to 150° C., preferably in the range from 80 to 120° C., and subsequently calcined at temperatures in the range from 150 to 500° C., preferably in the range from 200 to 450° C., in a gas stream comprising air or nitrogen.

Before or after drying or calcination, the shaping of the catalyst precursors is carried out, usually by kneading and extrusion or tabletting. A further possible way of preparing such catalysts is to fuse the iron components together with the promoters from groups a) and b) and subsequently to break up the melt cake to form granules. Fusion can be carried out by generally known methods, for example by resistance heating or inductively. After cooling of the melt cake, it is broken up by means of suitable apparatuses, for example jaw crushers, to a desired fineness, with oversize and undersize particles being sieved out. The catalyst is used as powder or preferably in the form of pieces in the process of the invention. Particle sizes having dimensions in the three spatial directions of at least 0.5 mm, preferably 1 mm, and not more than 15 mm, preferably not more than 10 mm and particularly preferably not more than 7 mm, are generally well-suited for use in conventional amalgam decomposers. To avoid the formation of regular three-dimensional structures, preference is given to using irregularly shaped particles, most conveniently crushed material.

The catalyst precursor in which the iron is present essentially as iron oxide, iron hydroxide and/or iron oxide hydroxide is converted by reduction into a porous catalyst comprising alpha-iron. These reduction processes are likewise known from ammonia catalysts. The reduction of the catalyst precursor to metallic iron is usually referred to as “activation”. For this purpose, the catalyst precursor is typically exposed to a reducing atmosphere, for example by treating with hydrogen or a nitrogen/hydrogen mixture at a temperature in the range from 300 to 500° C., preferably from 340 to 450° C. The treatment time is usually in the range from 12 to 120 hours, preferably in the range from 24 to 96 hours. The space velocity of gas over the catalyst in the activation is typically from 1000 to 10 000 standard l/kg of catalyst *h. The activation of the catalyst can be carried out directly in the amalgam decomposer. However, it is usually more convenient to place a prereduced and passivated catalyst in the decomposer and only reactivate this prereduced and passivated catalyst in the decomposer. This, too, is well-known from ammonia catalysts. In this case, the activation of the catalyst in a reactor suitable for this purpose is followed by passing an air/nitrogen mixture over the catalyst, usually at temperatures of not more than 100° C., preferably not more than 80° C., so as to passivate the catalyst by formation of a thin oxide layer on its surface. In this state, it can be handled conveniently (unpassivated alpha-iron can be pyrophoric) and can conveniently be introduced into the decomposer. Reactivation of the passivated catalyst in the decomposer is carried out like the activation itself, but requires only small amounts of hydrogen and a shorter time than the original activation of the oxidic catalyst. The passivated catalyst is typically reactivated by means of hydrogen or a nitrogen/hydrogen mixture at temperatures in the range from 300 to 500° C., preferably in the range from 320 to 400° C. The treatment is usually carried out for a time in the range from 6 to 72 hours, preferably in the range from 12 to 48 hours. The space velocity of gas over the catalyst in the reactivation is generally from 1 to 200 standard l/kg of catalyst*h, preferably from 25 to 75 standard l/kg of catalyst*h.

The catalyst is used in a conventional decomposer.

To carry out the process of the invention, the alkali metal amalgam and the alcohol are reacted in the decomposer charged with catalyst. The alcohol is usually used in excess, so that a solution of the alkali metal alkoxide in the corresponding alcohol is produced, since the separation of the alkali metal alkoxides, which in pure form are solid at ambient temperature, from the mercury or, in the case of incomplete reaction of the alkali metal, the amalgam depleted in alkali metal could otherwise only be carried out with difficulty. The process can be carried out batchwise or continuously; a continuous process is generally more economical. The alcohol and the amalgam are typically passed continuously in countercurrent through the decomposer charged with catalyst.

The mercury leaving the decomposer is returned to the production of alkali metal amalgam. In the case of incomplete reaction of the alkali metal, the amalgam depleted in alkali metal can also be returned to the production of alkali metal amalgam, but it can also, if desired, be recirculated to the reactor until the desired conversion of alkali metal has been reached. It is likewise possible to react amalgam depleted in alkali metal leaving the decomposer with another alcohol to form an alkoxide and mercury or with water to form alkali metal hydroxide and mercury.

The alkali metal alkoxide solution leaving the decomposer is either used directly or the alkali metal alkoxide present in it is isolated by customary methods, for example by evaporation of the solution and, if desired, subsequent purification, for example by recrystallization, or the solution is recirculated to the decomposer until the desired concentration of alkali metal alkoxide has been reached. The flow of alcohol through the reactor is preferably set so that an alkoxide solution of the desired concentration is taken from the decomposer without recirculation.

The reaction temperature is generally at least 0° C., preferably at least 10° C. and particularly preferably at least 20° C. Since the alkali metal alkoxide can decompose at excessively high temperatures, the reaction temperature cannot be chosen at will and its upper limit is the temperature at which decomposition results in a product loss which is no longer economically tolerable. Frequently and preferably, the reaction is carried out at the boiling point of the alcohol used.

Under some circumstances, especially in the reaction of relatively reactive alcohols (whose reactivity decreases, as is known, with the molecular weight of the alcohol and with the degree of branching of the substituent), it is necessary to remove the heat of reaction, and this is usually achieved by means of conventional cooling apparatuses.

The heat of reaction is, for example removed by cooling coils in or around the reactor, passing the streams leaving the reactor through heat exchangers or by evaporative or reflux cooling effected by alcohol boiling off. The hydrogen formed as a by-product is discharged from the decomposer in gaseous form and is disposed of, for example by incineration, or preferably utilized, for example as hydrogenation hydrogen for hydrogenation reactions.

The amount of catalyst (i.e. also the size of the decomposer), the residence time of the reactants in the reactor and the reaction temperature are chosen so that any decomposition of starting materials or products is avoided or remains within economically tolerable limits.

### EXAMPLES

### Example 1

### Preparation of a Catalyst According to the Invention

Magnetite ore was melted at a temperature of at least 1550° C. in air. The cooled melt block was broken up in a jaw crusher. A sieve fraction having a particle size of 1.5-3 mm was sieved out and reduced in a gas stream comprising hydrogen and nitrogen at 450° C. for 72 hours. After cooling under nitrogen, the catalyst precursor was passivated using a mixture of 1% by volume of air in nitrogen for 24 hours, with the amount of gas passed through the catalyst bed being regulated so that the temperature did not exceed 45° C. at any point in the bed. Before use for the amalgam decomposition, the catalyst was reduced by means of hydrogen at 340° C. for 46 hours. The reduced catalyst obtained in this way had the composition: 0.08% by weight of Al, 0.17% by weight of Mn, 0.12% by weight of Si, 0.01% by weight of Ti, 0.03% by weight of Ca, 0.05% by weight of Mg, 0.04% of C (not present as graphite), balance Fe, and its BET surface area was 6 m²/g.

### Example 2

### Amalgam Decomposition in the Laboratory

A bed of 500 ml of the catalyst from example 1 was placed in a glass reactor (upright tube). Potassium amalgam (0.411% by weight of K in Hg) was passed through this bed from the top downward at a flow rate of 6 l/h. At the same time, 400 g of t-butanol were circulated through the column at a flow rate of 10 l/h by pumping. The progress of the reaction is determined by acid-based titration of samples of the alcohol phase. The reaction was complete after 2.2 hours. The potassium tert-butoxide solution was drained and the amount of potassium tert-butoxide produced was found to be 0.76 mol by acid-based titration. The amount of potassium hydroxide formed as by-product was determined by means of Karl-Fischer titration. The calculated space-time yield of potassium tert-butoxide is 77 g/h*l.

### Example 3

### Amalgam Decomposition in the Laboratory

Example 2 was repeated using a potassium amalgam containing 0.340% by weight of K in Hg. 0.51 mol of potassium tert-butoxide was formed over a reaction time of 1.7 hours, corresponding to a space-time yield of 67 g/h*l.

### Example 4

### Amalgam Decomposition in the Laboratory (Comparative Example)

The procedure of example 2 was repeated using 375 ml of nonporous iron as catalyst (>98% of Fe, 1.4% of C) in the form of crushed material having a particle size of <2 mm and a BET surface area of 0.3 m²/g and using a potassium amalgam containing 0.393% by weight of K in Hg. 0.62 mol was formed over a reaction time of 15 hours, corresponding to a space-time yield of 12 g/h*l.

### Example 5

### Amalgam Decomposition in the Laboratory (Comparative Example)

The procedure of example 2 was repeated using 500 ml of nonporous iron as catalyst (>99% by weight of Fe, <0.2% by weight of C) in the form of crushed material having a particle size of 1-3 mm and a BET surface area of 0.2 m²/g and using a potassium amalgam containing 0.393% by weight of K in Hg. 0.15 mol was formed over a reaction time of 15 hours, corresponding to a space-time yield of 2 g/h*l.

The examples show that a considerable increase in the space-time yield is achieved by means of the process of the invention, so that either (which can be advantageous in new projects) the decomposers can be made considerable smaller or be used in smaller number for a constant production output, as a result of which the catalyst requirement also decreases, or alternatively a considerably higher production output is achieved. This improves the economics of the process very considerably.

1. A process for preparing alkali metal alkoxides by reacting alkali metal amalgam with alcohol in the presence of a catalyst comprising porous iron.

2. A process according to claim 1, wherein the catalyst has a BET surface area of at least 1 m²/g.

3. A process according to claim 1, wherein the catalyst comprises alpha-iron.

4. A process according to claim 2, wherein the catalyst comprises alpha-iron.

5. A process according to claim 4, wherein the catalyst is a commercial catalyst for the synthesis of ammonia in its reduced form.

6. A process according to claim 1, wherein an aliphatic primary, secondary or tertiary alcohol having from one to 8 carbon atoms in the alkyl radical is used.

7. A process according to claim 6, wherein methanol, ethanol or tert-butanol is used.

8. A process according to claim 6, wherein sodium or potassium is used as alkali metal.

9. A process according to claim 7, wherein sodium or potassium is used as alkali metal.
